(19) United States
(12) Patent Application Publication
(10) Pub. No.: US 2010/0118284 A1
(43) Pub. Date: May 13, 2010

(54) ANGLED LIGHT INTEGRATOR FOR A DISPLAY DEVICE

(76) Inventors: Ronald Ferguson, Grants Pass, OR (US); David Kerry Kiser, Sherwood, OR (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/618,602

(22) Filed: Nov. 13, 2009

Related U.S. Application Data
(60) Provisional application No. 61/114,145, filed on Nov. 13, 2008.

(51) Int. Cl. G03B 21/20; F21V 8/00

(52) U.S. Cl. 353/102; 362/559

(57) ABSTRACT

A light integrator for a display device is provided. The light integrator may include a first light tunnel configured to receive a light beam, increase the uniformity of the light distribution in the light beam, and output the light beam, the first light tunnel having a first optical axis. The light integrator may further include a redirection component configured to receive the light beam from the first light tunnel and redirect the light beam to a second light tunnel configured to further increase the uniformity of the light distribution in the light beam and transmit the light beam to downstream optical components, the second light tunnel having a second optical axis forming an angle less than 180 degrees and non-perpendicular with the first optical axis.

### CROSS REFERENCE TO RELATED APPLICATION

This application claims priority from U.S. Provisional Patent Application No. 61/114,145 of Ron Ferguson and David Kerry Kiser, entitled “ANGLED LIGHT TUNNEL FOR A PROJECTION DEVICE,” filed Nov. 13, 2008, the disclosure of which is hereby incorporated by reference in its entirety and for all purposes.

### BACKGROUND AND SUMMARY

Display devices, such as projection devices, may be used in a variety of environments including, but not limited to, home environments and applications, education environments and applications, business facilities, conference rooms and other meeting facilities, etc. Display devices may be adapted to project a variety of multimedia materials including, but not limited to, images, text, graphics, video images, still images, presentations, etc. A user may desire to employ the use of a single display device in multiple locations. Therefore, a user may want to physically move the display device between the locations. To increase the display device's portability the size of the display device may be reduced.

However, difficulties may arise when attempting to reduce the size of the display device due to constraints of various optical components in the display device. For example, the image characteristics of the display device may be compromised when the size of various optical components are reduced, leading to degraded image quality. For example in some display devices, light emitted from a light source, may be reflected by at least one or more minors, through a light integrator including a light tunnel, and then to an imaging device, such as a liquid crystal display (LCD) panel. In the light integrator light rays are reflected multiple times off of the sides of the light tunnel prior to output thereby increasing the uniformity of the light distribution. The length of the light tunnel may affect how evenly the output light is distributed. Thus, when a shorter light tunnel is used, the uniformity of the output light distribution is decreased. The longer tunnel may produce more evenly distributed light, but results in an increase in the overall length and/or size of the display device, thereby adversely affecting the device's compactness.

Other attempts have been made to fold the light integrator at a right angle in an attempt to reduce the length of the display device. For example in U.S. Pat. No. 5,625,738 a light integrator having a first segment forming a right angle with a second segment is disclosed. However, the width of the display device may be increased when a right-angle folded light tunnel is utilized, preventing a reduction in the size of the display device. Furthermore, the light integrator shown in U.S. Pat. No. 5,625,738 may be constructed as a single component which may increase the manufacturing cost of the light integrator.

To address these issues and as disclosed in more detail herein, a light integrator for a display device is provided. The light integrator may include a first light tunnel configured to receive a light beam, increase the uniformity of the light distribution in the light beam, and output the light beam, the first light tunnel having a first optical axis. The light integrator may further include a redirection component configured to receive the light beam from the first light tunnel and redirect the light beam to a second light tunnel configured to further increase the uniformity of the light distribution in the light beam and transmit the light beam to downstream optical components, the second light tunnel having a second optical axis forming an angle less than 180 degrees and non-perpendicular with the first optical axis.

In this way, the shape of the light integrator may be adjusted (e.g. angled) to conform to the arrangement of components within a display device, facilitating a reduction in size of the display device while increasing the uniformity of the light distribution. In other words, the shape of the light integrator may be tailored to fit the packaging constraints of a compact display device, while retaining the image characteristics (e.g. light distribution) of a larger display device.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 shows a schematic diagram of a display device including a light integrator.

FIG. 2 shows a first embodiment of the light integrator shown in FIG. 1.

FIG. 3 shows another embodiment of the light integrator shown in FIG. 1.

FIG. 4 shows an embodiment of the light integrator, shown in FIG. 1, forming an obtuse angle.

FIG. 5 shows an embodiment of the light integrator, shown in FIG. 1, including a first light tunnel having a length that is disproportional to a length of a second light tunnel.

FIG. 6 shows an embodiment of the light integrator, shown in FIG. 1, having tapered light tunnels.

FIGS. 7 and 8 show various embodiments of the light integrator, shown in FIG. 1, having a third light tunnel.

FIG. 9 shows a process flow for a light integrator included in a display device.

### DETAILED DESCRIPTION

As described in more detail herein, a light integrator for a display device is provided. In one example, the light integrator may include a first light tunnel configured to receive a light beam, increase the uniformity of the light distribution in the light beam, and output the light beam, the first light tunnel having a first optical axis. The light integrator may further include a redirection component configured to receive the light beam from the first light tunnel and redirect the light beam to a second light tunnel configured to further increase the uniformity in the light distribution in the light beam and transmit the light beam to downstream optical components, the second light tunnel having a second optical axis forming an angle less than 180 degrees and non-perpendicular with the first optical axis. In this way, the uniformity of the light distribution may be increased while allowing the light integrator to be angled to conform to the contours of the display device. Therefore, the size of the display device may be reduced, if desired, while increasing the uniformity of the light distribution to a desired level.

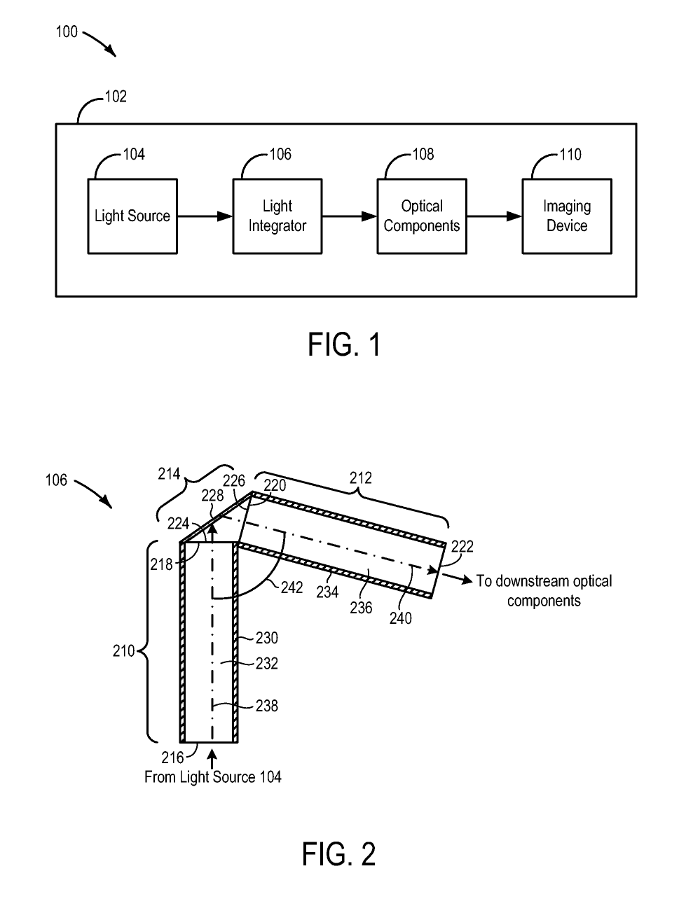

FIG. 1 illustrates generally an exemplary display device 100. As described and illustrated herein, display device 100 may be a projection device, such as a front projection device or front projector. In some examples, the projection device may be configured to be vertically mounted onto a ceiling or overhang. In other examples, the projection device may be configured to be positioned onto a surface such as a table, chair, etc. However, it should be appreciated that the display device may be another type of display device, including, but not limited to, a rear projector, a front projection television, a rear-projection television, etc. Further, the display device may be integrated within other systems, including but not limited to telephones, computers, etc.

Continuing with FIG. 1, display device 100 includes a housing or body 102. As further elaborated below, housing 102 may contain a light source 104, a light integrator 106, optical components 108, an imaging device 110, as well as other components which may assist in the generation of a projected image. The housing may include heat-reduction elements, including venting panels, fans, blowers, etc. allowing external air to circulate within display device 100, to cool the optical components (such as light source 104) as well as other electronic components within the display device and reduce any potential overheating during operation of the display device.

Light source 104 may be any suitable light source, including but not limited a high-intensity discharge (HID) lamp, light emitting diodes (LEDs), etc. In some examples, such as an HID lamp system, the light source may include a light gathering reflector and/or an arc lamp. The light gathering reflector may include an at least partially concave reflective surface, such as an ellipsoid, a parabola, etc. The arc lamp may comprise any of a variety of high intensity discharge lamps capable of producing sufficient light for display device 100, such as a halogen lamp, a high pressure mercury arc lamp, etc. It will be appreciated that the light source may produce a wide spectrum light beam. In other words, the light source may be configured to emit a light beam having a wide spectrum. As another example, in an LED system, an LED-based light source may include a cluster or array of LED. However, in other examples, individual LEDs may be utilized. It will be appreciated that other suitable light sources configured to generate a light beam for propagation to downstream components may be utilized. As described herein a light beam may include a plurality of light rays having discrete energy packets.

Light integrator 106 may in part function to increase the uniformity of light distribution of a light beam, such as by distributing at least a portion of the light from light source 104, substantially across an output aperture. The uniformity of the intensity of the distributed light may depend, at least in part, on the length of light integrator 106. As further elaborated with reference to FIGS. 2-8, light integrator 106 may be folded in an angled configuration to enable lengthening of the optical path without substantially increasing the length and/or size of the display device. In this way, the portability of the display device may be increased without compromising image quality.

Light having an increased uniformity may then travel from light integrator 106 through a plurality of optical components 108 before being directed and/or focused towards imaging device 110. The plurality of optical components 108 may include light filtering components, such as a color wheel, and one or more lenses, such as one or more focusing lenses, for focusing the distributed light towards the imaging device 110. Imaging device 110 may include one or more reflective LCD panels, transmissive LCD panels, LCOS panels, and/or a variety of other image producing devices. Additionally, display device 100 may also include projection optics (not shown), such as projection lenses for example, for projecting the generated images onto a display surface.

FIG. 2 illustrates a first embodiment of light integrator 106. In the depicted embodiment, the light integrator is in an acute angle configuration. However, as discussed in greater detail herein, the angle formed by the optical axes of the light integrator may be adjusted based on various factors such as the arrangement, size, and shape of other components in the display device. As previously discussed, the light integrator may be configured to receive a light beam from light source 104 and transmit a light beam having increased light distribution uniformity. In some examples, the light beam may be substantially homogenized upon passage through the light integrator such that the intensity of the light exiting the light integrator may be substantially uniform. However, in other examples, the light beam may not be substantially homogenized upon passage through the light integrator.

Light integrator may include a first light tunnel 210 and a second light tunnel 212. The first light tunnel may be configured to increase the uniformity of the light distribution of a light beam traveling through the light integrator and the second light tunnel may be configured to further increase the uniformity of the light distribution in the light beam. The light integrator may further include a redirection component 214, interposed between the first light tunnel 210 and the second light tunnel 212. The redirection component may be configured to redirect the light beam from the first light tunnel into the second light tunnel. In this way, the direction of the light may be altered, allowing the light integrator to be angled.

In some examples the first light tunnel, the second light tunnel, and the redirection component may be separately manufactured and subsequently assembled, to reduce the manufacturing cost of the light integrator. However in other examples, the first light tunnel, the second light tunnel, and the redirection component may be manufactured as a single component.

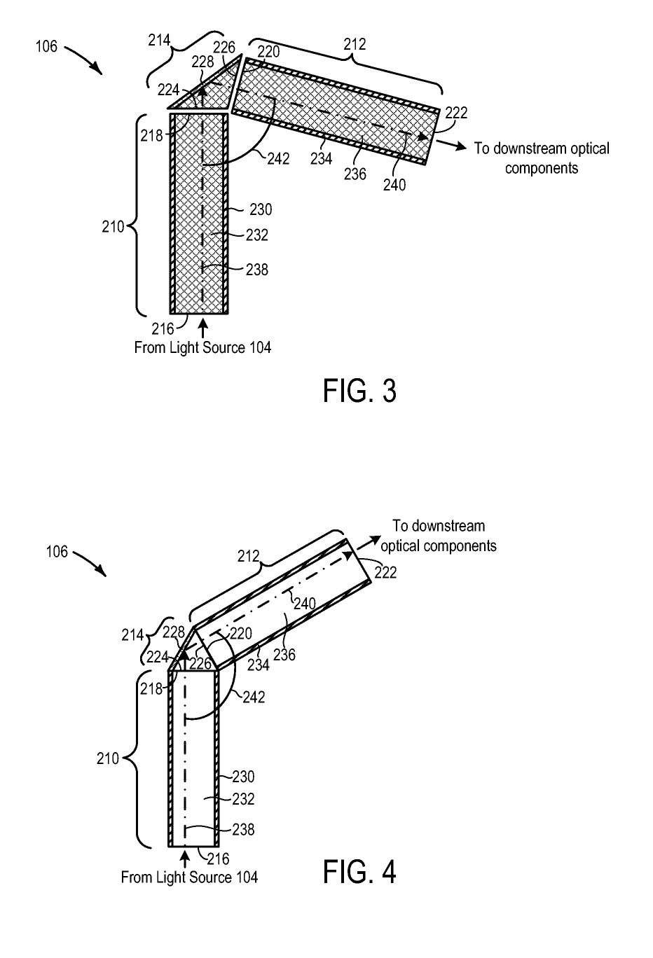

The first light tunnel 210 may include an input end 216 for receiving light and an output end 218 for transmitting light. Similarly, the second light tunnel 212 may include an input end 220 and an output end 222. Redirection component 214 may also include an input end 224 and an output end 226. Further the redirection components may include a reflective surface 228. In the depicted embodiment reflective surface 228 is a reflective mirror. However, in other embodiments, such as shown in FIG. 3, the reflective surface may be a surface in a prism, such as a total internal reflection (TIR) prism.

In the depicted embodiment, output end 218 of the first light tunnel may be in direct contact with input end 224 of the redirection component. Likewise, input end 220 of the second light tunnel may be in direct contact with output end 226 of the redirection component. Alternatively, there may be a partial gap between the first light tunnel 210, the redirection component 214, and/or the second light tunnel 212. For example the gap may be 100 microns or less. Further still in other examples, the first light tunnel and/or the second light tunnel may be positioned such that they are spaced apart from the redirection component.

The first light tunnel 210 may further include a first reflective outer casing 230 and a first transmissive core 232. Similarly the second light tunnel 212 may include a second reflective outer casing 234 and a second transmissive core 236. It will be appreciated that light rays included in an input light beam may be propagated through the first light tunnel via the reflection of the light rays off opposing sides of the reflective outer casing 230 Likewise, the light beam may be propagated through the second light tunnel via the reflection of light rays off opposing sides of the reflective outer casing 234. In the depicted embodiment the first transmissive core 232 and the second transmissive core 236 are hollow. However, in other embodiments, such as the example depicted in FIG. 3, one or both of the transmissive cores (232 and 236) may be formed out of a solid and transparent material, such as glass (e.g. doped glass) or a polymeric material (e.g. plastic). Additionally, it will be appreciated that the reflective outer casing may be a reflective minor or other suitable reflective device. However, when a solid and transparent transmissive core is utilized the reflective outer casing may be a surface of the glass or plastic, in some embodiments. Further, in some embodiments the input ends (216 and 220) and the output ends (218 and 222) of the first and second light tunnels may be rectangular or square in shape and four reflective surfaces may extend down the length of the light tunnel from the input end. Thus, in such example, the reflective surfaces (e.g. the tunnel walls) may be perpendicular at their abutting edges. However, in other embodiments, alternate light tunnel configurations may be utilized.

The first light tunnel 210 has a first optical axis 238 and the second light tunnel has a second optical axis 240. In this example, the optical axes are longitudinally aligned with the light tunnels. It will be understood that the optical axes are not in alignment with the reflected light rays within the light tunnels. However, in other examples alternate alignments are possible. The optical axes may define an angular relationship between the first and the second light tunnels. Therefore, the first optical axis and the second optical axis form an angle 242. In the depicted embodiment the angle is acute. However, in other embodiments other suitable angles may be formed. For example, the angle may be obtuse. Thus in some examples, the angle may be non-perpendicular and less than 180 degrees. The angle formed between the first and second optical axes may be selected based on packaging considerations (e.g. component layout, size and shape of the housing, etc.) in the display device. Light integrators with alternate angles shown in FIGS. 4-8 are discussed in greater detail herein.

FIG. 3 shows a second embodiment of light integrator 106. As previously discussed, the light integrator may be configured to receive a light beam from light source 104 and transmit a light beam having an increased uniformity of light distribution to downstream components. As the light integrator depicted in FIG. 3 includes similar components to the light integrator shown in FIG. 2, the components are labeled similarly.

As depicted in FIG. 3 the first transmissive core 232 and the second transmissive core 236 may be solid. For example a transparent material such as glass, doped glass, a polymeric material (e.g. plastic), etc., may substantially fill the core of the first and/or second light tunnel. When a solid transmissive core is used the reflective outer casing may be a surface of the solid transparent material. However in other embodiments, the reflective outer casing may be a reflective minor. Further, in other examples, the first transmissive core 232 may be hollow and the second transmissive core 236 may be formed out of a solid and transparent material or visa-versa. In this way, at least one of the first transmissive core and the second transmissive core may be formed out of glass or plastic and at least one of the first transmissive core and the second transmissive core is hollow. Continuing with FIG. 3, the redirection component may be a prism, such as a total internal reflection (TIR) prism. The prism may be constructed out of a suitable material, such plastic or glass. However, in other embodiments the redirection component may include a reflective mirror, as previously discussed.

Output end 218 of the first light tunnel 210 may be spaced apart from the input end 224 of redirection component 214. Likewise, input end 220 of the second light tunnel 212 may be spaced apart from the output end 226 of the redirection component. Alternatively, there may be a partial gap between the first light tunnel and/or second light tunnel and the redirection component. For example the partial gap may be 100 microns or less. Further still in other examples, the first light tunnel and/or the second light tunnel may be positioned such that they are in direct contact with the redirection component.

FIG. 4 illustrates another example of light integrator 106. The light integrator depicted in FIG. 4 includes similar components to the light integrator shown in FIG. 2. Thus, related, components are labeled accordingly.

As shown, angle 242 formed by first optical axis and the second optical axis may be opened beyond 90 degrees. For example, FIG. 4 illustrates the light integrator wherein the first and second optical axes form an obtuse angle. However, it will be appreciated that the angle depicted in FIG. 4 is exemplary in nature and numerous alternate angles may be formed between the first and second optical axes in other embodiments.

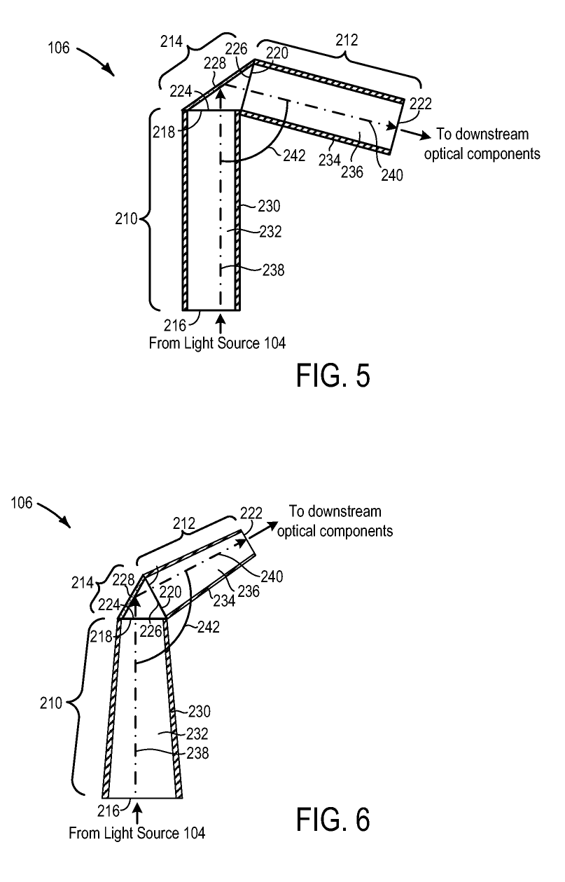

FIG. 5 illustrates another embodiment of light integrator 106. The first light tunnel 210 may be configured to increase the uniformity of the light distribution in a light beam by a first amount and the second light tunnel 212 may be configured to increase the uniformity of the light distribution in the light beam by a second amount that is disproportional to the first amount. As previously discussed the length of a light tunnel may correspond to an amount by which the uniformity of the light distribution is increased. Therefore, as shown in FIG. 5 the length of the first light tunnel 210 may be disproportional to the length of the second light tunnel 212.

The lengths of the light tunnels may be selected based on the desired uniformity of the light distribution in the display device as well as various packaging considerations of the display device. For example, an overall light tunnel length (i.e. summation of the length of the first and second light tunnels) may be selected based on the desired uniformity of the light distribution. Accordingly the angle formed by the optical axes as well as the length of the light tunnels may be chosen based on the selected overall light tunnel length as well as the layout of various components within the display device. However, in other examples, alternate techniques may be used to select the angle formed by the optical axes and the lengths of the light tunnels. As such, the first light tunnel may be an extended length relative to the second light tunnel or vise versa.

FIG. 6 depicts another embodiment of light integrator 106. In the depicted example, the first light tunnel 210 and the second light tunnel 212 are tapered. As such, the width and/or height of input end 216 of the first light tunnel may be larger than the width and/or height of output end 218 of the first light tunnel. Similarly the width and/or height of input end 220 of the second light tunnel may be larger than the width and/or height of output end 222 of the second light tunnel. In this way, the output of the light integrator may be sized to attach to downstream components. It will be appreciated that when a square or rectangular light tunnel is utilized each of the opposing walls may be correspondingly tapered, in some examples. In other examples, the first light tunnel may be tapered and the second light tunnel may be substantially straight or visa-versa.

The redirection component may be sized to receive a light beam from the first tapered light tunnel and redirect the light beam to the second tapered light tunnel. As depicted, the first optical axis and the second optical axis form an acute angle. However, in other examples, alternate angles may be formed depending on the size and layout of other optical and electronic components in the display device.

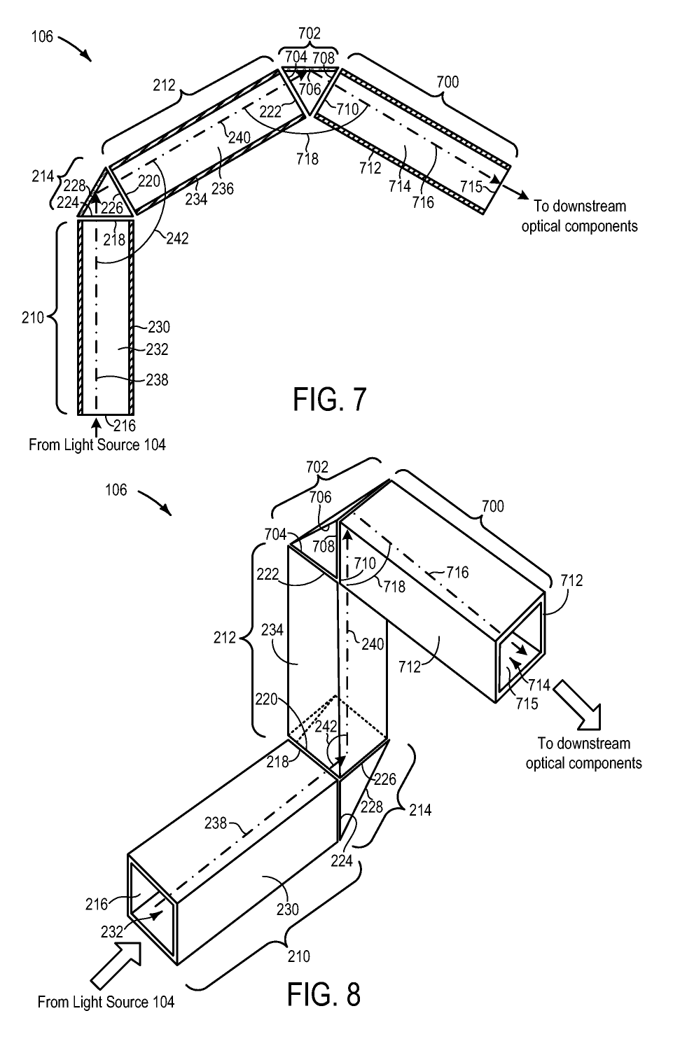

FIGS. 7 and 8 illustrate alternate embodiments of light integrator 106. In the illustrated embodiments the light integrator includes a third light tunnel 700 which may be used to further increase the uniformity of the light distribution in a light beam travelling through the light integrator. Additionally a second redirection component 702 configured to redirect a light beam may also be included in the light integrator.

The second redirection component may include an input end 704 configured to receive light from the second light tunnel 212. The second redirection component may also include a reflective surface 706 and an output end 708. The reflective surface may be a reflective mirror, a surface of a prism, etc. The second redirection component may direct a light beam to an input end 710 of the third light tunnel. The third light tunnel may be configured to further increase the uniformity of the light distribution in the light beam travelling through the light integrator. Additionally the third light tunnel may include a reflective outer casing 712, a transmissive core 714, and an output end 715. The third light tunnel may also include a third optical axis 716. The second optical axis 240 and the third optical axis 716 may form an angle 718. In FIG. 7 angle 718 is an obtuse angle and in FIG. 8 angle 718 is a right angle. It will be appreciated that alternate angles may be formed in other embodiments, such as an acute angle.

Further, as shown in FIG. 7 the third optical axis 716 may be parallel to a plane defined by the first and second optical axes (238 and 240). In FIG. 8, the third optical axis may extend through the plane defined by the first and second optical axes. In particular the third optical axis is perpendicularly arranged with respect to the first and second optical axes. However, in other examples, the orientation of the third optical axis may be altered. In either case the third optical axis forms an angle with the second optical axis that is less than 180 degrees. In some embodiments, the third optical axis may form an acute angle with the second optical axis.

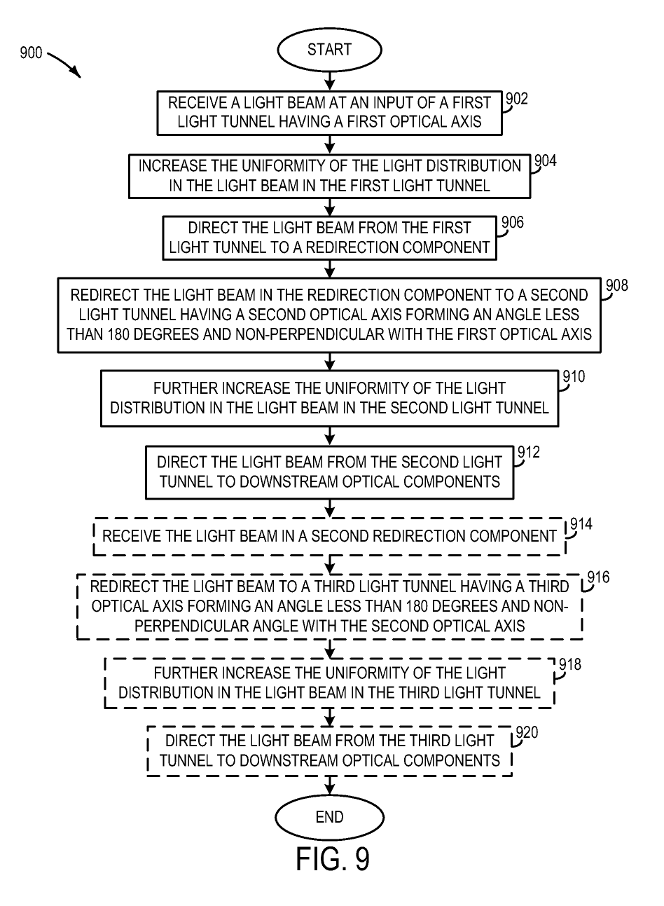

FIG. 9 illustrates a method 900 for operation of a light integrator included in a display device. The method 900 may be implemented using the systems, devices, and components described herein, and/or via any other suitable systems, devices, and components.

At 902, method 900 includes receiving a light beam at an input of a first light tunnel having a first optical axis. At 904 the method includes increasing the uniformity of the light distribution in the light beam in the first light tunnel and at 906 the method includes directing the light beam from the first light tunnel to a redirection component.

Next at 908 the method includes redirecting the light beam in the redirection component to a second light tunnel having a second optical axis forming an angle less than 180 degrees and non-perpendicular with the first optical axis. In this way, the direction of the light beam may be altered allowing the light integrator to be angled. At 910 the method includes further increasing the uniformity of the light distribution of the light beam in the second light tunnel and at 912 directing the light beam from the second light tunnel to downstream optical components.

In one embodiment, the downstream optical components may include one or more lenses, an imaging device, etc. However in another embodiment the downstream optical components may include a second redirection component and a third light tunnel configured to further increase the uniformity of light distribution of the light beam. Therefore, at 914 the method may further include receiving the light beam in a second redirection component and at 916 redirecting the light beam to a third light tunnel having a third optical axis forming an angle less than 180 degrees and non-perpendicular with the second optical axis.

At 918 the method includes further increasing the uniformity of the light distribution of the light beam in the third light tunnel. Next at 920 the method includes directing the light beam from the third light tunnel to downstream optical components. After 920 the method ends. In other examples, steps 914-920 may not be included in method 900.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A light integrator for a display device comprising:
a first light tunnel configured to receive a light beam, increase the uniformity of the light distribution in the light beam, and output the light beam, the first light tunnel having a first optical axis; and
a redirection component configured to receive the light beam from the first light tunnel and redirect the light beam to a second light tunnel configured to further increase the uniformity of the light distribution in the light beam and transmit the light beam to downstream optical components, the second light tunnel having a second optical axis forming an angle less than 180 degrees and non-perpendicular with the first optical axis.

2. The light integrator of claim 1, wherein the first light tunnel includes a first transmissive core and a first reflective outer casing and the second light tunnel includes a second transmissive core and a second reflective outer casing.

3. The light integrator of claim 2, wherein at least one of the first transmissive core and the second transmissive core is formed out of glass or plastic and wherein at least one of the first transmissive core and the second transmissive core is hollow.

4. The light integrator of claim 1, wherein the first light tunnel is configured to increase the uniformity of the light distribution in the light beam by a first amount and the second light tunnel is configured to increase the uniformity of the light distribution in the light beam by a second amount that is disproportional to the first amount.

5. The light integrator of claim 1, wherein the angle formed by the first optical axis and the second optical axis is selected based on the layout of additional optical and electronic components included in the display device.

6. The light integrator of claim 1, wherein the angle formed by the first optical axis and the second optical axis is an acute angle.

7. The light integrator of claim 1, wherein the redirection component is a total internal reflective prism.

8. The light integrator of claim 1, wherein the redirection component is in direct contact with the first light tunnel and the second light tunnel.

9. The light integrator of claim 1, wherein the redirection component is spaced apart from the first light tunnel and the second light tunnel.

10. The light integrator of claim 1, further comprising a second redirection component configured to receive an output beam from the second light tunnel and redirect the light beam to a third light tunnel having a third optical axis forming an angle less than 180 degrees and non-perpendicular with the second optical axis, the third light tunnel configured to receive the light beam from the second redirection component, further increase the uniformity of the light distribution in the light beam, and transmit the light beam to downstream optical components.

11. A method for operation of a light integrator included in a display device comprising:
receiving a light beam at an input of a first light tunnel having a first optical axis;
increasing the uniformity of the light distribution in the light beam in the first light tunnel;
directing the light beam from the first light tunnel to a redirection component;
redirecting the light beam in the redirection component to a second light tunnel having a second optical axis forming an angle less than 180 degrees and non-perpendicular with the first optical axis;
further increasing the uniformity of the light distribution in the light beam in the second light tunnel; and
directing the light beam from the second light tunnel to downstream optical components.

12. The method of claim 11, further comprising:
receiving the light beam in a second redirection component; and
redirecting the light beam to a third light tunnel having a third optical axis forming an angle less than 180 degrees and non-perpendicular with the second optical axis;
further increasing the uniformity of the light distribution in the light beam in the third light tunnel; and
directing the light beam from the third light tunnel to downstream optical components.

13. The method of claim 12, wherein the third optical axis extends through a plane defined by the first optical axis and the second optical axis.

14. The method of claim 11, wherein the first light tunnel includes a first transmissive core and a first reflective outer casing and the second light tunnel includes a second transmissive core and a second reflective outer casing.

15. The method of claim 14, wherein at least one of the first transmissive core and the second transmissive core is hollow and at least one of the first transmissive core and the second transmissive core is formed out of a solid transparent material.

16. The method of claim 11, wherein the angle formed by the first optical axis and the second optical axis is obtuse.

17. A projection device comprising:
a light source configured to emit a light beam;
a light integrator including:
a first light tunnel configured to receive the light beam from the light source, increase the uniformity of the light distribution in the light beam by a first amount and output the light beam, the first light tunnel having a first optical axis;
a redirection component configured to receive the light beam from the first light tunnel and redirect the light beam to a second light tunnel configured to increase the uniformity of the light distribution in the light beam by a second amount and transmit the light beam to a downstream imaging device configured to generate an image for projection, the second light tunnel having a second optical axis forming an angle less than 180 degrees and non-perpendicular with the first optical axis.

18. The projection device of claim 17, wherein the first light tunnel includes a first transmissive core and a first reflective outer casing and the second light tunnel includes a second transmissive core and a second reflective outer casing.

19. The projection device of claim 17, wherein the angle formed by the first optical axis and the second optical axis is selected based on the layout of additional optical and electronic components included in the display device.

20. The projection device of claim 17, wherein the angle formed by the first optical axis and the second optical axis is obtuse.
